(19) United States
(12) Patent Application Publication
(10) Pub. No.: US 2024/0367987 A1
(43) Pub. Date: Nov. 7, 2024

(54) PORE EXPANSION IN MESOPOROUS Y MATERIALS

(71) Applicants: The Regents of The University of California, Oakland, CA (US); Chevron U.S.A. Inc., San Ramon, CA (US)

(72) Inventors: Alexander Katz, Richmond, CA (US); Xuemin Li, Berkeley, CA (US); Alexander E. Kuperman, Moraga, CA (US); Jinyi HAN, San Ramon, CA (US)

(73) Assignees: The Regents of The University of California, Oakland, CA (US); Chevron U.S.A. Inc., San Ramon, CA (US)

(21) Appl. No.: 18/644,306

(22) Filed: Apr. 24, 2024

Related U.S. Application Data
(60) Provisional application No. 63/499,669, filed on May 2, 2023.

(51) Int. Cl. C01B 39/24

(52) U.S. Cl. CPC C01B 39/24; C01P 2006/16

(57) ABSTRACT

Provided is a method of preparing mesopore Y zeolite catalysts with larger mesopore sizes. The method employs swelling agents, and optionally cosolvents. The larger mesopores improve accessibility for mass transport of bulky reactants. In the preparation a swelling agent is used in combination with cetyltrimethylammonium bromide (CTAB). Cosolvents can also be used to affect a strong swelling effect.

### CROSS-REFERENCE TO RELATED APPLICATIONS

The present application claims priority to U.S. provisional patent application 63/499,669 filed on May 2, 2023, the disclosure of which is hereby incorporated by reference in its entirety.

### BACKGROUND

Surfactant-templating approaches have been widely used in mesoporous silica synthesis as exemplified by the successful synthesis of ordered mesoporous molecular sieves (MCM-41) with pore sizes ranging from 2 to 10 nm by using cetyltrimethylammonium bromide (CTAB) as the template under basic conditions. It was shown early on that these materials are amorphous—not crystalline—based on a Raman spectroscopic analysis. This approach provided a rational method of controlling mesopore diameter by increasing surfactant alkyl chain length. In addition, swelling agents, such as 1,3,5-trimethylbenzene (TMB), 1,3,5-triisopropylbenzene, isopropylbenzene, tridecane and para-xylene (p-xylene) proved to be efficient at expanding the pore diameter of MCM-41 materials up to 20 nm, while also modifying the textural properties of the resulting mesoporous silicates. In particular, both TMB and p-xylene have been extensively used as swelling agents to increase the mesopore diameter of micelle-templated silica (MTS). These two swelling agents have been compared in MTS syntheses employing C₁₆TAB surfactant assemblies. With TMB as a swelling agent, an increasing MTS mesopore size from 3.9 nm to 9.0 nm was reported when using TMB/C₁₆TAB ratios increasing in the range from 0 to 13 (with a plateau observed at 8.5 nm with a TMB/C₁₆TAB ratio of 5). With p-xylene as a swelling agent, the same authors report a mesopore size of 3.9 nm at a p-xylene/C₁₆TAB ratio of 2, and, upon increasing this ratio in the range of 5-20, there was growth of an additional mesopore, thereby creating a bimodal mesopore size distribution, in the range of 8.0 nm to 16.5 nm.

Following the success of MCM-41S-type materials syntheses, surfactant templating approaches have been extended to the synthesis of other materials, such as mesoporous polymers, mesoporous metal oxides, and mesoporous metal organic frameworks (MOFs). Among them, the synthesis of mesoporous zeolites has garnered great attention due to the reason that the surfactant templating method provides an approach for mesoporosity introduction within a zeolite, while preserving strong acidity and high hydrothermal stability of the zeolite. Notably, Garcia-Martinez et al. reported on the synthesis of mesoporous Y zeolites using a surfactant-templating method starting from Y zeolites (Zeolyst CBV720 with Si/Al=15) with NH₄OH (or other bases such as NaOH, Na₂CO₃ or tetrapropylammonium hydroxide (TPAOH)), combined with the formation of a mesoporous phase via trimethylalkylammonium bromide (CₙTAB, n=16 and 18) as surfactant. Their results demonstrate that a mesopore size around 3.8 nm is produced when using C₁₆TAB as the surfactant, which can be increased by enlarging the carbon length of the alkyl chain (C₈TAB, C₁₀TAB, C₁₂TAB, C₁₄TAB, C₁₆TAB, and C₁₈TAB) in the surfactants. Using this approach, the mesopore diameter of mesoporous Y zeolites has been increased up to 5.3 nm when using C₂₂TAB as the surfactant. Similar approaches of tailoring surfactant size have also been used to control mesoporosity in ZSM-5 zeolites, when using (CH₃O)₃SiC₃H₆N⁺(CH₃)₂CₙH₂ₙ₊₁ as the surfactant.

The effect of the NaOH/SiO₂ ratios on the mesoporosity of synthesized samples using octadecyltrimethylammonium bromide (C₁₈TAB) as surfactant has also been studied. The data demonstrate an amorphous wall when using a NaOH/SiO₂ ratio range of 0.125 to 0.25 in the mesoporous Y zeolite synthesis. It was also shown that upon increasing the NaOH/SiO₂ ratio from 0.05 to 0.25, the mesopore size decreased from 4.30 nm to 3.91 nm. This indicates that NaOH concentration has little effect on the mesopore size, but it results in larger mesopore volumes, smaller zeolitic nanodomains, lower acidity and lower micropore volumes.

Addition of a cosolvent has also been widely used to increase mesopore size in MTS systems. The physiochemical properties of cosolvent, such as its polarity and dielectric constant, as well as its amount were reported to influence d-spacing, mesopore size, mesophase transition, and morphology of mesoporous silica. Also, the effect of cosolvents in conjunction with surfactant templating strategies has been previously investigated in mesoporous zeolite syntheses involving Y zeolite, ZSM-5 zeolite, and NaX zeolite. These have all used C₁₆TAB-surfactant templating using a bottom-up method (i.e., not postsynthetic modification of a zeolite or zeolite precursor), which proved that the cosolvent plays different roles including that of a self-assembly modulator, in addition to a mesopore size expander. However, reports of using cosolvents in the presence of swelling agents in surfactant templating syntheses remain rare.

### SUMMARY

Provided is a method of preparing mesopore Y zeolite catalysts with larger mesopore sizes. The method employs swelling agents, and optionally cosolvents. The larger mesopores improve accessibility for mass transport of bulky reactants.

In the preparation a swelling agent is used in combination with cetyltrimethylammonium bromide (CTAB). It has been found that such a combination of materials can increase the mesopore size of the Y material upwards of 6.8 nm, with a mesopore volume of up to 0.41 cm²/g. Cosolvents can also be used to affect a strong swelling effort.

The swelling agents can be any swelling agent that is suitable. In one embodiment, the swelling agents can comprise 1,3,5-trimethylbenzene (TMB) or para-exylene (p-xylene). In one embodiment a cosolvent is also used. The cosolvents can be any suitable cosolvent to help aid a strong swelling effect. The cosolvent in the present method is generally an alcohol. In one embodiment, the cosolvent can comprise ethanol or tert-butyl alcohol (TBA).

Among other factors, the use of swelling agents, optionally together with cosolvents such as alcohols, has been found to be able to expand on the mesopore size of CTAB-templated mesopore Y zeolites. The use of swelling agents in the synthesis of Y zeolites has been found to extend the mesopore size. In one embodiment, the use of TMB provides excellent results. The addition of a cosolvent, such as an alcohol cosolvent, can further expand the mesopore size. In one embodiment, TBA as a cosolvent provides excellent results.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1A depicts nitrogen physisorption isotherms at 77 K with TMB.

FIG. 1B depicts DFT pore size distributions of samples synthesized using different TMB/C₁₆ TAB ratios.

FIG. 1C depicts the evolution of mesopore size maximum versus a TMB/C₁₆ TAB ratio.

FIG. 1D depicts nitrogen physisorption isotherms at 77 K with p-xylene.

FIG. 1E depicts DFT pore size distributions of samples synthesized using different p-xylene/C₁₆ TAB ratios.

FIG. 1F depicts the evolution of mesopore size maximum versus the p-xylene/C₁₆ TAB ratio.

FIG. 2A depicts nitrogen physisorption isotherms at 77 K with ethanol.

FIG. 2B depicts DFT pore size distributions of samples synthesized using different ethanol/TMB/C₁₆ TAB ratios.

FIG. 2C depicts the maximum pore size distribution D (nm) with and without ethanol addition at different TMB amounts.

FIG. 2D depicts nitrogen physisorption isotherms at 77 K with TBA.

FIG. 2E depicts DFT pore size distributions of samples synthesized using different TAB/TMB/TBA ratios.

FIG. 2F depicts the maximum pore size distribution D (nm) with and without TBA addition at different TMB amounts.

FIG. 3A depicts nitrogen physisotherms at 77 K for Cis TAB.

FIG. 3B depicts DFT pore size distributions of samples using different ratios of TMB swelling agent/Cis TAB.

FIG. 3C depicts maximum pore size distribution D (nm) using C₁₈ TAB versus maximum in mesopore size distribution D (nm) using C₁₆ TAB.

FIG. 3D depicts maximum distribution D (nm) for materials synthesized with C₁₆ TAB and C₁₈ TAB.

FIG. 4A depicts nitrogen physisorption isotherms at 77 K.

FIG. 4B depicts DFT pore size distributions of different samples.

FIG. 4C depicts maximum pore size distribution with ethanol and TBA additions as cosolvents.

### DETAILED DESCRIPTION

Before the present processes for achieving pore expansion in mesoporous materials are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

Provided is a method of preparing mesopore Y zeolite catalysts with larger mesopore sizes. The method employs swelling agents, and optionally cosolvents. The larger mesopores improve accessibility for mass transport of bulky reactants.

Reference will now be made in detail to exemplary aspects of the present disclosure that are illustrated in the accompanying drawings.

It has been found that swelling agents, cosolvents, and cosurfactants can impact the mesopore size distribution in C₁₆TAB- and C₁₈TAB-templated mesoporous Y syntheses. The present process expands pore size in mesoporous Y zeolites beyond what has heretofore been attainable. While surfactants with longer alkyl chain length produced slightly larger mesopore sizes, adding swelling agents extended the mesopore size further, with TMB exhibiting a stronger mesopore size expansion effect than p-xylene. A sample synthesized with a TMB/C₁₈TAB ratio of 12 exhibited the largest mesopore size of 6.8 nm, with a mesopore volume of 0.41 cm³/g. The addition of cosolvents could also alter the mesopore size, with TBA generally showing a stronger effect at mesopore expansion compared to ethanol, but the effect of cosolvent addition became less pronounced as the TMB/CₙTAB ratio increased.

The present process comprises combining CTAB with a Y zeolite, a swelling agent and sodium hydroxide solution. The mixture is heated and stirred. When the reaction is complete and solids have precipitated, the mixture is cooled and the solids filtered. The solids can be washed with water to attain a neutral pH. The filtered solids can then be dried can calcined. The swelling agent, in one embodiment, is TMB or para-xylene, with TMB being the preferred swelling agent. The CTAB, in one embodiment, is either C₁₆TAB or C₁₈TAB. The combination of C₁₈TAB and the selling agent TMB has been found quite advantageous. In one embodiment, the Y zeolite is CBV270.

In another embodiment, the process comprises first combining the sodium hydroxide solution with CTAB and the swelling agent. The resulting mixture is then heated as noted above. The heating can continue for 20-40 minutes at a temperature in the range of from 85-95° C., and then the Y zeolite is added to the mixture with the mixture being stirred until the reaction is complete. In one embodiment, as noted above, the CTAB is either C₁₆TAB or C₁₈TAB. In one embodiment, the swelling agent is TMB or para-xylene. And, as noted above, in one embodiment, the Y zeolite is CBV270.

The stirring of the reaction mixture contains for a time of 4-7 hours. In one embodiment, the stirring continues for about 6 hours. Once the reaction is complete and solids have precipitated, the mixture is cooled or allowed to cool, generally to room temperature. The precipitated solids are then filtered. In one embodiment, the solids are washed several times with water until the filtrate is of neutral pH. The neutral pH can be detected by pH paper.

The filtered solids, whether washed or not, are then calcined. The calcination can generally be conducted in the temperature range of from 550-650° C. In one embodiment, the temperature is about 580° C. The calcination will generally be conducted for several hours, e.g., 4-7 hours. In one embodiment, the calcination is conducted for about 5 hours. The calcination is also, in one embodiment, conducted in dry air. The mesopores of the Y zeolite are significantly larger on an average basis than those of the original or parent Y zeolite.

In the present process, the CTAB can be any suitable CTAB. In one embodiment, the CTAB is C₁₆TAB or C₁₈TAB. The larger alkyl chain in the CTAB surfactant generally provides enlarged mesopores. In one embodiment, C₁₈ TAB is used in the process.

The swelling agent is generally TMB or para-xylene. Both have been found to improve and enhance the size of the mesopores in combination with CTAB. In one embodiment, TMB is used as the swelling agent. Using TMB in conjunction with C₁₈TAB has been found to be quite beneficial and successful in expanding the mesopores. This is particularly true when the molar ratio of TMB to C₁₈TAB is about 12.

The molar ratio of the TMB or par-xylene swelling agent to the CTAB surfactant is generally in the range of from 4 to 12. In one embodiment, the molar ratio is about 6, and in another embodiment is about 12.

In one embodiment, an alcohol cosolvent is also used together with the swelling agent. The alcohol cosolvent can be in the initial mixture of the CTAB, Y zeolite, swelling agent and sodium hydroxide solution. When the Y zeolite is added subsequently to creating an initial mixture comprising sodium hydroxide aqueous solution, CTAB and swelling agent, the cosolvent can then be added after the Y zeolite is added.

In this embodiment, the initial mixture is heated for 20-40 minutes, e.g., about 25 minutes, and then the Y zeolite is added to the mixture with stirring. The cosolvent can then be added 20-40 minutes later, e.g., about 30 minutes, after the addition of the Y zeolite. This later process has been found to work quite well when using a cosolvent.

The alcohol cosolvent can be any suitable cosolvent. In one embodiment, the alcohol cosolvent can be ethanol or TBA. The alcohol solvent is preferably a larger molecule alcohol, such as TBA. Improved expansion of the mesopores is realized when using a larger molecule alcohol such as TBA.

The Y zeolite can be any suitable Y zeolite. Generally, the Y zeolite comprises mesopores to begin with. CBV720 is such a Y zeolite. The present process works particularly well with CBV720.

In one embodiment, a nonionic surfactant can be used in conjunction with the CTAB surfactant. It has been found that a nonionic surfactant together with the CTAB surfactant and TMB swelling agent can provide advantageous results.

The following examples are provided to further illustrate the present process and Y material with larger mesopores. The examples, however, are not meant to be limiting.

### Materials

The water used in all experiments was deionized. The chemicals used for the experiments were hexadecyltrimethylammonium bromide (C₁₆TAB, Sigma-Aldrich), trimethyloctadecylammonium bromide (C₁₈TAB, Sigma-Aldrich), sodium hydroxide (Pellets, Neta Scientific Inc), parent Y zeolite CBV720 (ZE0290, Si/Al=15, Zeolyst), 1,3,5-trimethylbenzene, (TMB, Sigma-Aldrich), para-xylene (p-xylene, Sigma-Aldrich), 1, 4-diisopropylbenzene (DIPB, Sigma-Aldrich), ethanol (Sigma-Aldrich), tert-butyl alcohol (TBA, Sigma-Aldrich). NH₄NO₃ (Sigma-Aldrich, >99.5%), 2-methoxynaphthalene (2-MN, Sigma-Aldrich, 99%), acetic anhydride (Ac₂O, Sigma-Aldrich, 99.5%), 1, 2-dichloroethane (DCE, Sigma-Aldrich, 99.8%), 1-acetyl-2-methoxynaphthalene (1, 2-AMN, TCI Chemicals, >98.0%), 2-acetyl-6-methoxynaphthalene (2,6-AMN, Sigma-Aldrich, 98.0%). All the chemicals, except Ac₂O and DCE (which are dried with P₂O₅/K₂CO₃ and CaH₂, respectively, and subsequently stored under N₂ atmosphere), were used without further purification.

Mesoporous Y Synthesis Using CₙTAB (n=16 and 18) as the Surfactant

Conventional surfactant-templated mesoporous Y zeolite was synthesized using the procedure described below, which is modified from the established procedures in the literature. Instead of adding all the reagents into a plastic container before heating as described in the literature, the parent zeolite CBV720 was introduced after the entire solution reached a set temperature. Thus, 0.5 g hexadecyltrimethylammonium bromide (C₁₆TAB) and 20 mL NaOH solution (0.16 M unless specified (NaOH/SiO₂ ratio of 0.19), which falls into the NaOH/SiO₂ range of producing an amorphous wall via zeolite dissolution) were added to a plastic container and heated in a 90° C. oil bath for 25 min. Subsequently, 1.0 g of parent zeolite CBV 720 was added to the solution. The molar composition of the mixture were 1.00 SiO₂:0.192 Na:0.082 CₙTAB (n=16 and 18):66.7 H₂O, and this mixture was stirred for 6 h. After cooling, the contents were poured onto a filter, and the precipitated solids were washed several times with water, until the filtrate became neutral as measured with pH paper. The sample was then dried at 60° C. overnight and was calcined at 580° C. for 5 h in dry air.

### Mesoporous Y Synthesis Using CₙTAB and Swelling Agents

The synthetic approach for preparing mesoporous Y zeolite together with swelling agents was similar to the procedure of surfactant-templated mesoporous Y above, except that various amounts of swelling agents (1,3,5-trimethylbenzene (TMB); para-xylene (p-xylene); DIPB) were added after C₁₆TAB or C₁₈TAB, as shown in Scheme 1 below. In a typical synthesis, 0.5 g of C₁₆TAB, 1.0 g TMB (0.87 g p-xylene; 1.35 g DIPB), and 20 mL NaOH solution (0.16 M) were added to the plastic bottle and heated in an oil batch at 90° C. for 25 min. Subsequently, 1.00 g of parent zeolite CBV 720 was added to the solution. The molar composition of the obtained mixture was 1.0 SiO₂:0.19 Na:0.082 CₙTAB (n=16 and 18):0.49 swelling agent and 66.7 H₂O. If cosolvents were used, either ethanol or TBA was added into the solution 30 min later after the addition of the parent zeolite CBV 720, and the molar ratio of cosolvent to C₁₁TAB (n=16 and 18) was 14.6:1. This mixture was stirred for 6 h. After cooling, the contents were filtered, and the solids were washed several times with water until the filtrate became neutral as measured with pH paper. The sample was then dried at 60° C. overnight, and was calcined at 580° C. for 5 h in dry air.

The obtained samples were designated as CₙTAB (n=16 and 18)+x swelling agent (+14.6 cosolvent), where x is the molar ratio of swelling agent/CₙTAB. The proton form materials were obtained via ion-exchange with 1 M NH₄NO₃ aqueous solution (liquid to zeolite weight ratio of 50:1) at 60° C. for 24 h followed by the same washing and drying procedure described above. This ion-exchange procedure was repeated for another two times before calcination according to the same procedure described above.

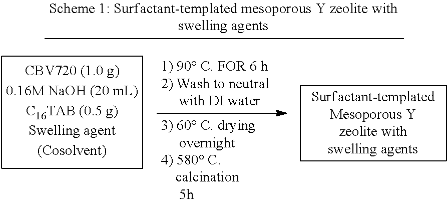

### Post-Synthetic Approach for Mesoporous Y Material Synthesis

0.5 gas-made mesoporous Y material using C₁₆TAB as the surfactant was mixed with 4.04 g TMB (TMB to C₁₆TAB molar ratio of 70) to make a suspension, which was transferred into a Teflon-lined autoclave and heated to 160° C. for 16 h. After cooling, the contents were washed several times with either water or a mixture of water and ethanol followed by drying and calcination. The obtained samples were designated as C₁₆TAB+70TMB postsynthesis and C₁₆TAB+70TMB postsynthesis (water and ethanol).

### Material Characterization

N₂ physisorption isotherms were measured at 77 K on a Micromeritics ASAP2020 adsorption instrument. Prior to sample analysis, the sample was degassed at 350° C. for 4 hours under vacuum to remove the residuals. The total surface area was calculated from the Brunauer-Emmett-Teller (BET) equation. The micropore volume, micropore surface area, and the external surface area were measured by the t-plot method. The mesopore volume was calculated from the adsorption branch using the Barrett-Joyner-Halenda (BJH) method. X-Ray diffraction (XRD) patterns were collected on a Rigaku MiniFlex diffractometer using a Cu Kα radiation (40 kV, 15 mA) ranging from 5 to 500 with a step size of 0.01°. SEM was performed with a Zeiss Crossbeam 550 scanning electron microscope operated at 1 kV and 5.0 mm working distance.

### Friedel Crafts Acylation of 2-Methoxynaphthalene (2-MN)

Friedel Crafts Acylation (FCA) of 2-methoxynaphthalene (2-MN) using acetic anhydride (Ac₂O) as the acylating agent was carried out to investigate the catalytic site accessibility of the synthesized materials. The as-made zeolite was calcined in a tube furnace and transferred moisture-free to an Ar-filled glovebox for reaction preparation. Solid 2-MN was brought to an Ar-filled glovebox for reaction preparation. For a typical run, 100 mg of selected material and 1.1 mmol of 2-MN were loaded into separate Schlenk tubes and sealed to maintain a moisture free environment. The tubes were placed in a N₂ atmosphere, where 10 mL of dry DCE, 0.31 mL Ac₂O (˜3.3 mmol) and 250 μL of dodecane (as an internal standard) were syringed in an air-free manner to the tube containing the organic solid. The molar ratio of 2-MN to Ac₂O was 1 to 3. Then the catalyst and reagent tube were heated to the reaction temperature of 40° C. for 15 minutes, prior to introducing the reagent solution to the heated catalyst via cannula transfer where the reaction took place for 10 minutes. Upon reaction completion, the solution was syringed through a 0.2 μm PTFE filter, and was analyzed with an Agilent 6890 GC system equipped with a flame ionization detector (FID) and HP-1 column (50 m×0.32 mm×1.05 m). For all reactions, both the carbon balance and the mole balance reach near completion, with measured balances at >90% and >95% respectively. The main product formed was 1-acetyl-2-methoxynaphthalene (1, 2-AMN) with a selectivity higher than 97% for all experiments.

### Results, Discussion, and Conclusions

### Effect of C₁₆TAB Surfactant and Swelling Agents

Conventional C₁₆TAB-templated mesoporous Y exhibits a 3.5 nm mesopore which is absent in parent CBV720 zeolite. This mesopore size is similar to the size previously reported for related mesoporous Y materials in the literature. Compared with parent CBV720 zeolite, the total mesopore volume of conventional C₁₆TAB-templated mesoporous Y is 2.5-fold higher. When mesoporous Y is synthesized at a higher NaOH concentration of 0.2 M instead of 0.16 M NaOH, (i) a nearly unchanged mesopore size; (ii) an increased mesopore volume (0.59 to 0.67 cm³/g)—a trend observed previously; and (iii) a slightly decreased recovered yield are observed. This suggests a higher base concentration does not enlarge mesopore size of conventional mesoporous Y.

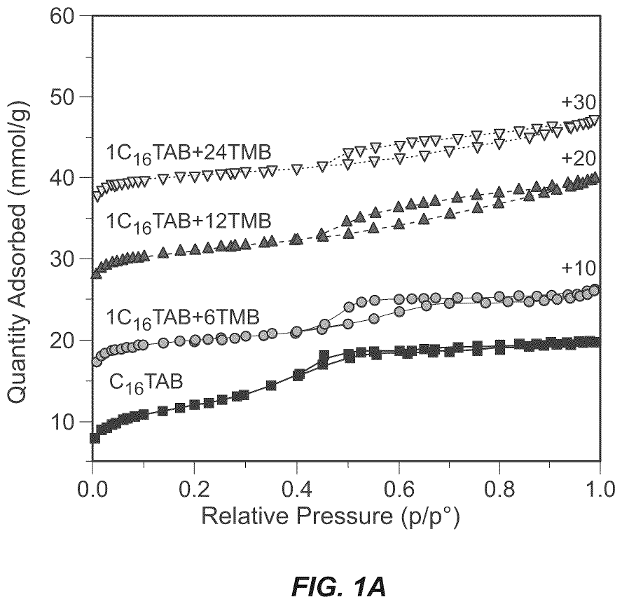

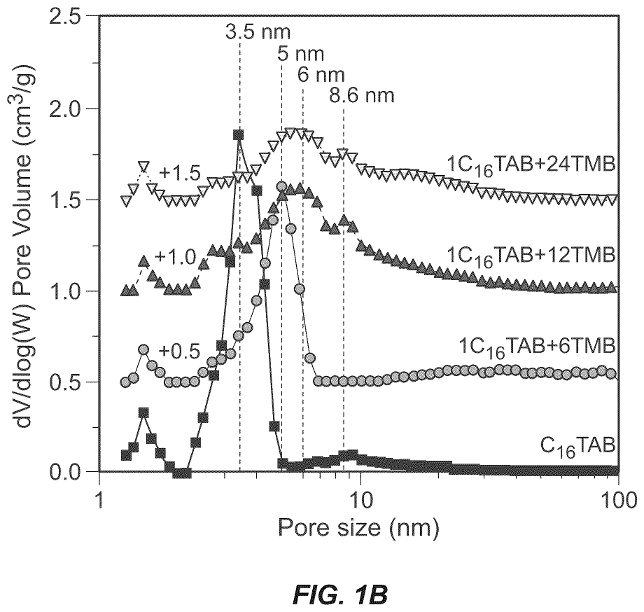

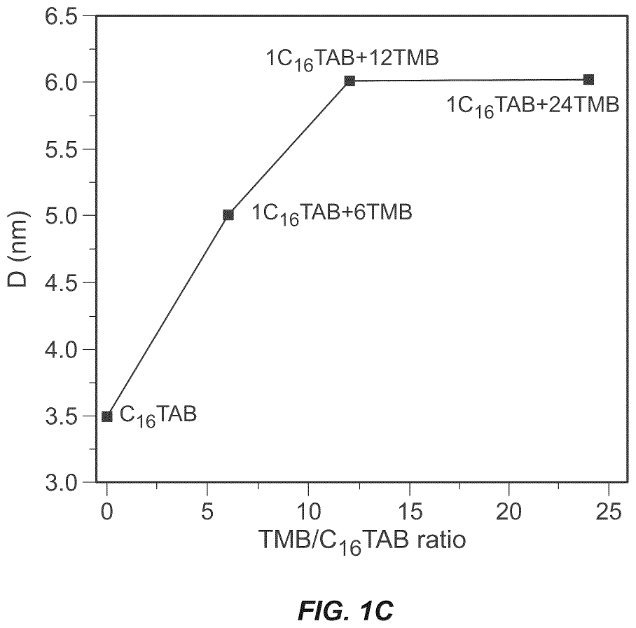

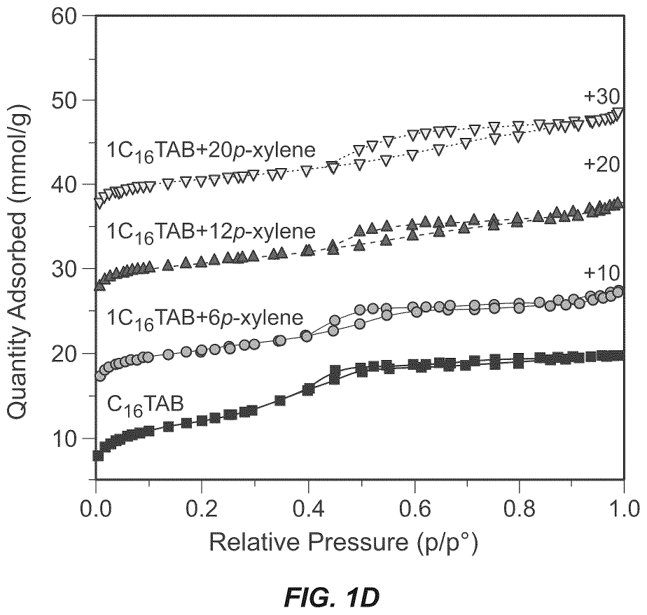

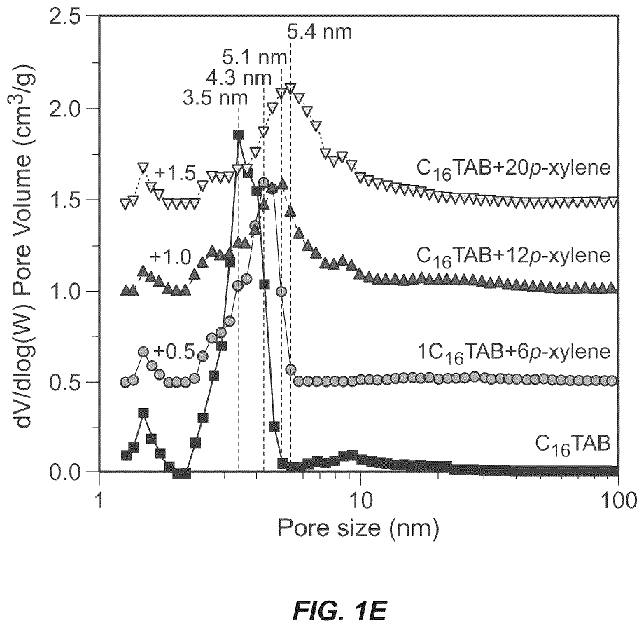

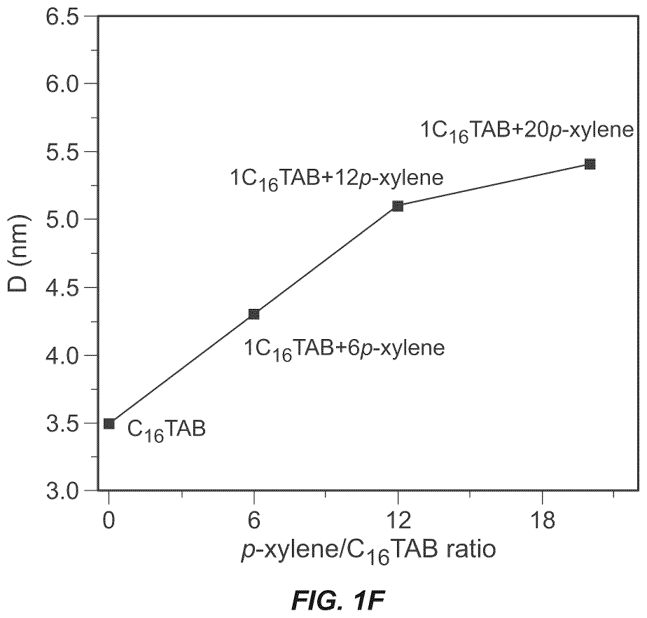

The results of using C₁₆TAB together with p-xylene and TMB as swelling agents in the synthesis of mesoporous Y are shown in FIGS. 1A-1F. It is observed that the mesopore size maximum increases from 3.5 to 6.0 nm as the TMB/C₁₆TAB ratio increases from 0 to 12, with a plateau in the mesopore size upon further increasing the TMB/C₁₆TAB in the range of 12 to 24. (FIGS. 1B and 1C). The existence of this plateau when using TMB as a swelling agent is shared in common with previously reported MTS syntheses, albeit in the latter systems, the plateau occurred at a lower TMB/C₁₆TAB ratio of 5. The plateau in both cases is believed driven by a saturation capacity of the surfactant assembly to accommodate TMB. Based on this premise, it surprisingly appears that the surfactant assemblies and their related capacities to accommodate TMB are enhanced for the present mesoporous Y synthesis compared to the reported MTS syntheses.

When using p-xylene as a swelling agent in the present synthesis, the mesopore size maximum increases from 3.5 to 5.4 nm as the p-xylene/C₁₆TAB ratio increases from 0 to 20. (FIGS. 1E and 1F). The smaller size of p-xylene relative to TMB seems to result in less effective swelling and thus the need to compensate by using more of it, in order to achieve the same mesopore size (i.e., similar mesopore size maximum was obtained at a p-xylene/C₁₆TAB ratio of 12 (5.1 nm) and a TMB/C₁₆TAB ratio of 6 (5.0 nm), see Table 1 below). However, the ultimate maximum pore size achievable was higher with TMB than p-xylene as a swelling agent in the present system—again emphasizing the apparent important role of the greater steric bulk of the former.

As shown in Table 1, compared with conventional C₁₆TAB-templated mesoporous Y, samples comprising added TMB or p-xylene had decreased mesopore volumes and increased micropore volumes. The decrease in the former overwhelmed the increase in the latter in this comparison, leading to an overall decrease in total pore volume when synthesizing mesoporous Y without swelling agents. This result is contrary to literature MTS materials syntheses, where addition of swelling agents increased the mesopore size as well as the total pore volume. These contrasting results between the two systems can be ascribed to different pore shapes.

In summary, a mesoporous Y material was synthesized with a mesopore size centered at 6.0 nm using a TMB/C₁₆TAB ratio of 12. This sample had the highest mesopore volume of 0.49 cm³/g among the C₁₆TAB-templated samples synthesized using the swelling agents in Table 1. The addition of swelling agents controlled the mesopore volume and increased the mesopore size.

TABLE 1
Textural properties of the synthesized samples using different TMB/C₁₆TAB ratios.

| | Mesopore | | | | | | | |
|---|---|---|---|---|---|---|---|---|
| | size | Surface area (m²/g) | | | Volume (cm³/g) | | | Yield^{f} |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} | (%) |
| C₁₆TAB | 3.5 | 968 | 348 | 620 | 0.74 | 0.15 | 0.59 | 86 |
| 1C₁₆TAB + 6TMB | 5.0 | 832 | 519 | 313 | 0.57 | 0.21 | 0.36 | 74 |
| 1C₁₆TAB + 12TMB | 6.0 | 907 | 507 | 400 | 0.70 | 0.21 | 0.49 | 74 |
| 1C₁₆TAB + 24TMB | 6.0 | 863 | 569 | 294 | 0.60 | 0.23 | 0.37 | 78 |
| 1C₁₆TAB + 6p-xylene | 4.3 | 846 | 428 | 418 | 0.62 | 0.17 | 0.45 | 83 |
| 1C₁₆TAB + 12p-xylene | 5.1 | 877 | 489 | 388 | 0.62 | 0.20 | 0.42 | 83 |
| 1C₁₆TAB + 20p-xylene | 5.4 | 889 | 521 | 368 | 0.66 | 0.21 | 0.45 | 82 |

^{a}S_{BET} = BET surface area (total surface area);
^{b}S_{micro} = micropore surface area, t-plot method;
^{c}Sₑₓₜₑᵣₙₐₗ = external surface area;
^{d}V_{micro} = micropore volume, t-plot method;
^{e}Vₘₑₛₒ = mesopore volume, BJH adsorption branch;
^{f}Yield = (weight of inorganics after final synthesis step/weight of inorganics originally into the synthesis) where inorganic refers to aluminosilicate zeolite.

The PXRD patterns of the samples synthesized using C₁₆TAB as the surfactant and TMB or p-xylene as swelling agent show the characteristic peaks of FAU zeolite at 20 of 6.16, 10.13, 15.69, and 23.82 et al., including the parent CBV720 zeolite, and the sample synthesized with C₁₆TAB at a higher NaOH concentration of 0.2 M instead of 0.16 M. Based on the data, it can be concluded that qualitatively, all of the samples exhibited a degree of crystallinity that is comparable to the parent CBV720 zeolite. This conclusion is supported by quantitative crystallinity studies in the literature, which show only slight decreases in crystallinity in mesoporous Y relative to precursor materials.

In addition, when DIPB was applied as a swelling agent with a DIPB/C₁₆TAB ratio of 12, no evidence for the synthesis of larger or additional mesopores, compared with parent CBV720 zeolite was observed. The high hydrophobicity of DIPB seems to have caused it not to incorporate into the surfactant assembly, because of competitive adsorption of DIPB into the bulk of the zeolite Y. Such a result suggests an optimum hydrophobicity of a swelling agent, which is well represented in TMB, in which there is more steric bulk of alkyl substituents compared with p-xylene, but not so much as in DIPB such that adsorption into the zeolite interior pores rather than the mesoporous surfactant assembly dominates. Thus, in one embodiment, TMB is used as the swelling agent with great advantage.

### Effect of Ethanol or Tert-Butyl Alcohol (TBA) as a Cosolvent

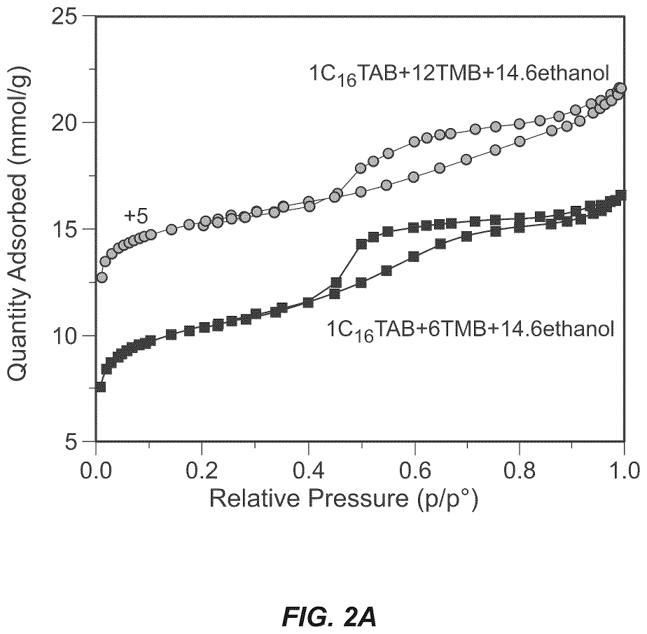

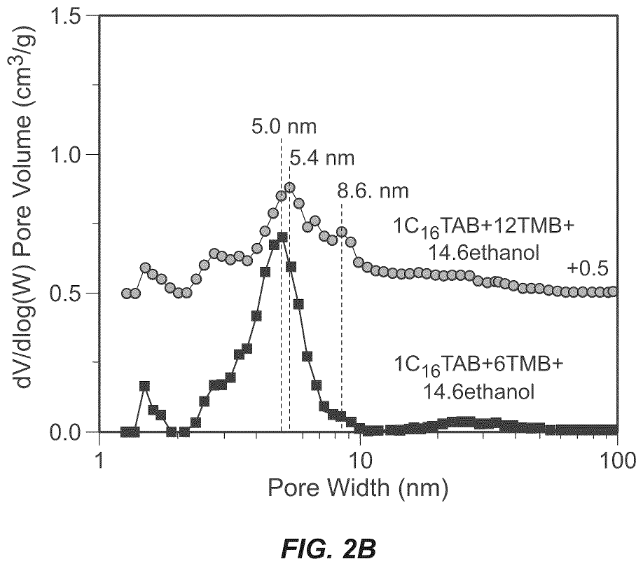

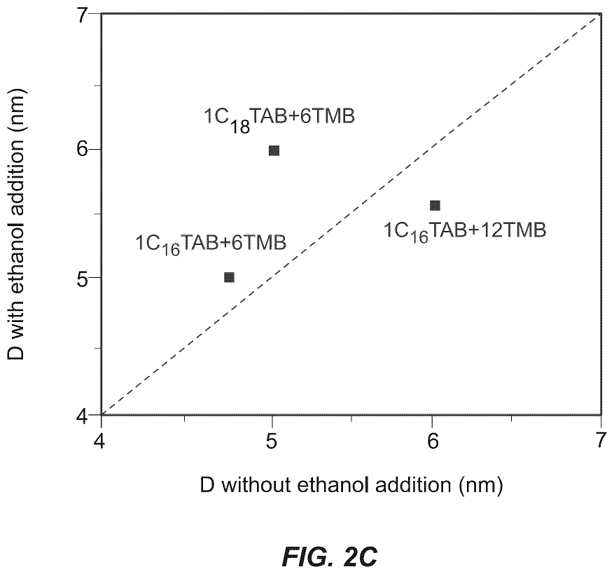

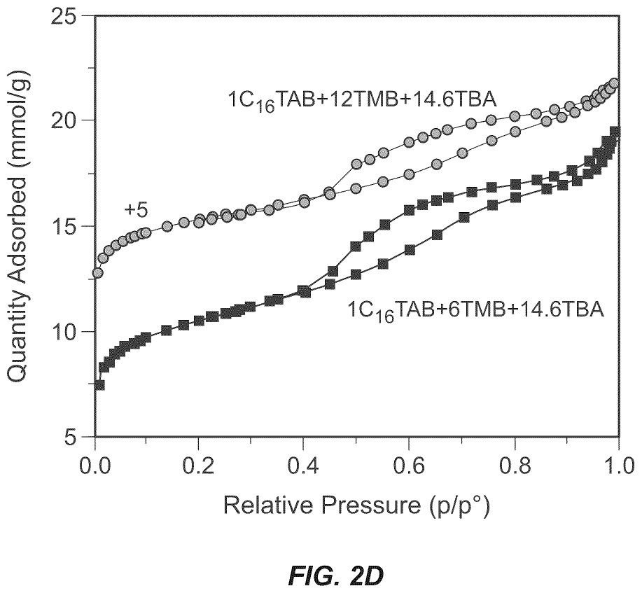

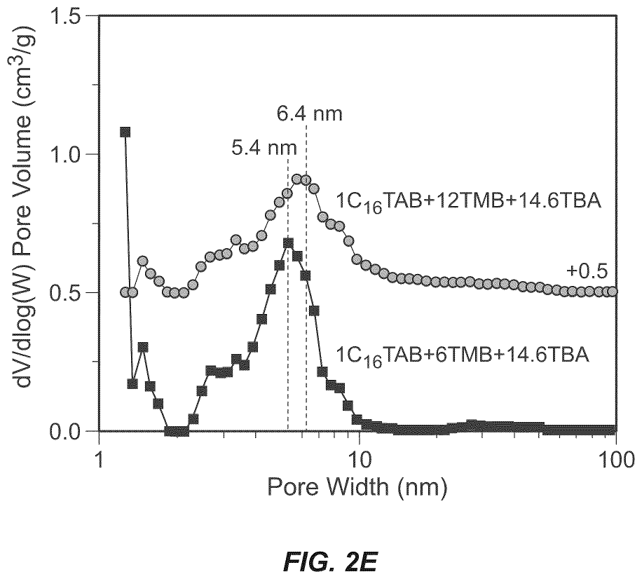

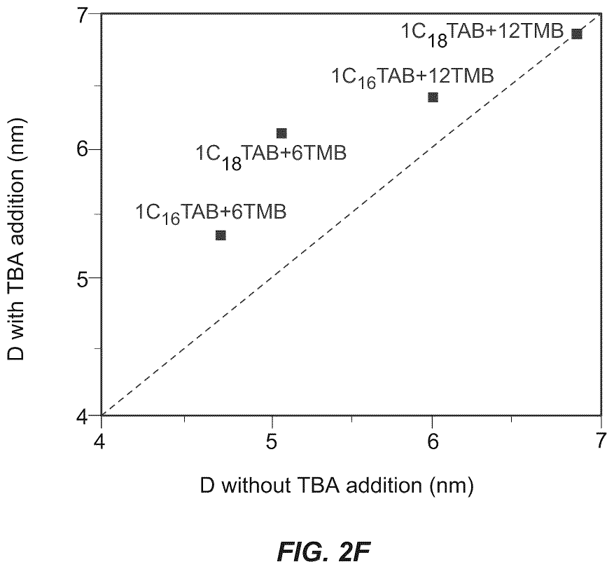

Based on the best results above obtained with TMB as a swelling agent, TMB was combined with cosolvents consisting of either ethanol or TBA, in an attempt to further increase mesopore size in surfactant-templated mesoporous Y materials. The addition of ethanol did not change the mesopore size at a TMB/C₁₆TAB ratio of 6 (5.0 nm both with and without ethanol addition), and decreased the mesopore size at a TMB/C₁₆TAB ratio of 12 (from 6.0 nm without ethanol to 5.4 nm within ethanol in FIGS. 1B and 2B). When TBA was added as a cosolvent, the mesopore size increased from 5.0 nm to 5.4 nm at a TMB/C₁₆TAB ratio of 6, and from 6.0 nm to 6.4 nm at a TMB/C₁₆TAB ratio of 12 (FIGS. 1B and 2E). In summary, the addition of ethanol has no contribution at a TMB/C₁₆TAB of 6, and decreases the mesopore size by 10.0% (6.0 to 5.4 nm) at a TMB/C₁₆TAB of 12. The addition of TBA increased the mesopore size by 8.0% and 6.7% (5.0 to 5.4 nm and 6.0 to 6.4 nm) at a TMB/C₁₆TAB ratio of 6 and 12, respectively. FIGS. 2C and 2F show these effects of cosolvent using a parity plot.

The addition of cosolvents can control the solubility of the swelling agent within the surfactant assembly. Upon adding ethanol, the solubility of TMB in solution (i.e. outside of the micelle core) increased, resulting in less TMB incorporation in the surfactant assembly and smaller mesopores. This phenomenon is more pronounced at a higher TMB/C₁₆TAB ratio as shown in FIG. 2C. However, TBA is less soluble than ethanol in water, and it is therefore less efficient at increasing the solubility of TMB in solvent. In addition, compared to ethanol, the molecular size of TBA makes it large enough to increase the mesopore size when swelling the surfactant assembly. This is confirmed by the same mesopore size achieved when using the 1C₁₆TAB+6TMB+14.6TBA composition compared with the 1C₁₆TAB+12TMB+14.6 ethanol composition, as shown in FIGS. 2B and 2E. As a result, unlike ethanol (FIG. 2C), the addition of TBA played a positive effect on the mesopore size, as shown in FIG. 2F. Therefore, in one embodiment, TBA is used as a cosolvent to great advantage.

Both cosolvents investigated (ethanol and TBA) caused an increase in the mesopore volume at a TMB/C₁₆TAB ratio of 6 and a decrease at a TMB/C₁₆TAB ratio of 12, when comparing with materials in the absence of added cosolvents in Table 1. The best results are observed upon addition of TBA at a TMB/C₁₆TAB ratio of 6, which increased the mesopore volume up to 0.51 cm³/g compared with 0.38 cm³/g for the control in the absence of TBA. The data in Table 2 (relative to controls in Table 1) also demonstrate slightly higher recovered yields upon cosolvent addition. According to PXRD, the crystallinity of samples prepared using addition of TBA and ethanol cosolvents result in similar characteristic peak intensities corresponding to FAU zeolite compared with control materials synthesized in the absence of cosolvents.

TABLE 2
Textural properties of the synthesized samples using ethanol and TBA as the cosolvents.

| | Mesopore | | | | | | | |
|---|---|---|---|---|---|---|---|---|
| | size | Surface area (m²/g) | | | Volume (cm³/g) | | | Yield^{f} |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} | (%) |
| 1C₁₆TAB + 6TMB + 14.6ethanol | 5.0 | 868 | 507 | 361 | 0.58 | 0.20 | 0.38 | 85 |
| 1C₁₆TAB + 12TMB + 14.6ethanol | 5.4 | 863 | 541 | 323 | 0.57 | 0.22 | 0.35 | 79 |
| 1C₁₆TAB + 6TMB + 14.6TBA | 5.4 | 867 | 445 | 422 | 0.69 | 0.18 | 0.51 | 81 |
| 1C₁₆TAB + 12TMB + 14.6TBA | 6.4 | 860 | 541 | 320 | 0.59 | 0.22 | 0.37 | 77 |

^{a}S_{BET} = BET surface area (total surface area);
^{b}S_{micro} = micropore surface area, t-plot method;
^{c}Sₑₓₜₑᵣₙₐₗ = external surface area;
^{d}V_{micro} = micropore volume, t-plot method;
^{e}Vₘₑₛₒ = mesopore volume, BJH adsorption branch;
^{f}Yield = (weight of inorganics after final synthesis step/weight of inorganics originally into the synthesis) where inorganic refers to aluminosilicate zeolite.

### Effect of C₁₈TAB Surfactant and Swelling Agents

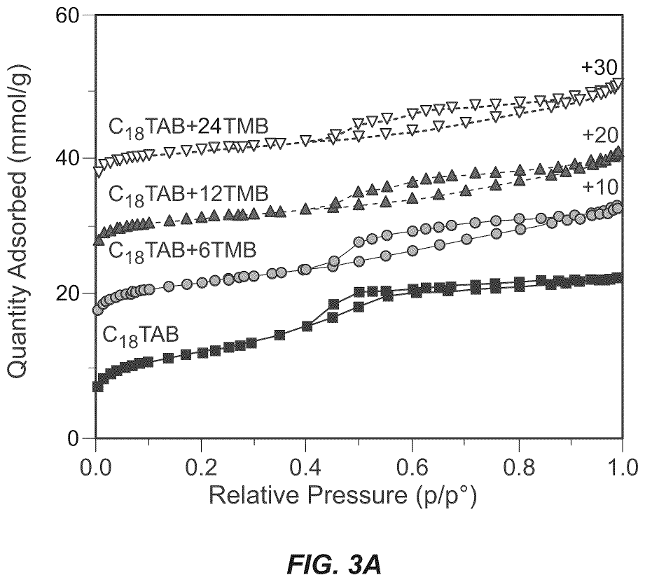

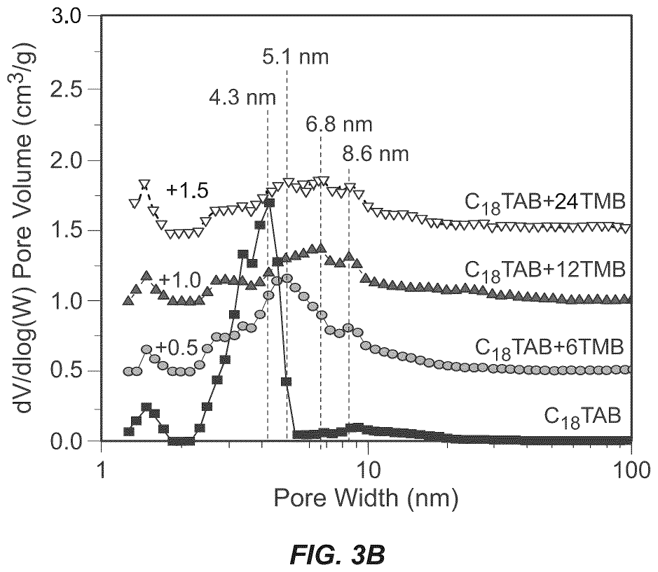

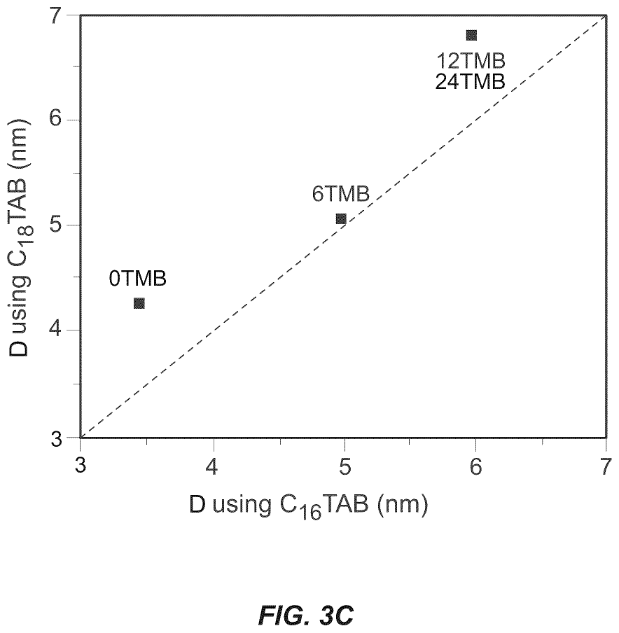

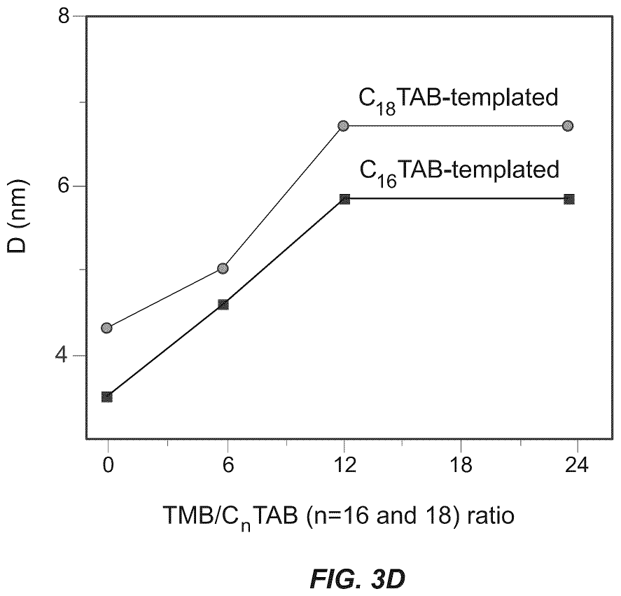

When using the sterically bulkier C₁₈TAB surfactant, the surfactant-only synthesis (NaOH/SiO₂ ratio of 0.19; 90° C. for 16 h) led to a mesopore size of 4.3 nm, as shown in FIG. 3B. When using C₁₈TAB surfactant under slightly different conditions (NaOH/SiO₂ ratio of 0.2; 115° C. for 20 h), a 4.1 nm pore size was obtained. A slightly larger mesopore size of 4.7 nm was obtained under other synthesis conditions using C₁₈TAB surfactant (NaOH/SiO₂ ratio of 0.10; 210° C. for 2 min). Compared with the results using C₁₆TAB surfactant (mesopore size of 3.5 nm), an increased mesopore size is generally observed upon increasing the alkyl chain length of the surfactant from C₁₆TAB to C₁₈TAB. This is consistent with prior results, which directly correlate the mesopore size to the surfactant alkyl chain length, for synthesis of mesoporous Y zeolites. Upon increasing the alkalinity of the NaOH solution employed in synthesis (0.2 M NaOH; NaOH/SiO₂ ratio of 0.24), synthesis of a reduced mesopore size of 3.5 nm was observed in the distribution, and a slightly higher mesopore volume of 0.72 cm³/g compared with 0.60 cm³/g. These trends are consistent with prior results when using C₁₈TAB to template mesoporosity in Y zeolite syntheses.

The effect of surfactant alkyl chain carbon length (C₁₆TAB and C₁₈TAB) on the mesopore size when using TMB as the swelling agent is shown in FIG. 3C. Except for a higher mesopore size as noted above, the C₁₈TAB-templated material exhibited nearly the same textural properties compared to a material synthesized using C₁₆TAB, as shown in Table 1. Samples synthesized using C₁₈TAB generally exhibit a larger mesopore size compared with those using C₁₆TAB.

Upon addition of TMB, the mesopore volume of the samples decreased, as shown in Table 3. This is the same trend as observed above in the C₁₆TAB-templated system. However, a larger mesopore volume is observed at a TMB/C₁₈TAB ratio of 6 in the C₁₈TAB system (0.51 cm³/g in Table 3), compared with a TMB/C₁₆TAB ratio of 12 in C₁₆TAB system (0.49 cm³/g in Table 1). It seems that in the C₁₈TAB-templated system, the effect of TMB as a swelling agent is more pronounced than in the corresponding C₁₆TAB-templated system. In addition, comparable recovered yields using different surfactants are observed, as shown by data in Tables 1 and 3. It is noteworthy that at a TMB/C₁₈TAB ratio of 12, a mesoporous Y material possessing a mesopore size of 6.8 nm was synthesized, which is the largest mesopore size among all of the materials investigated. It seems that the application of C₁₈TAB increases the mesopore size compared with what is attainable with C₁₆TAB, and the use of TMB as a swelling agent can further increase the mesopore size.

TABLE 3
Textural properties of the synthesized samples in C₁₈TAB-directed syntheses.

| | Mesopore | | | | | | | |
|---|---|---|---|---|---|---|---|---|
| | size | Surface area (m²/g) | | | Volume (cm³/g) | | | Yield^{f} |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} | (%) |
| C₁₈TAB | 4.3 | 940 | 359 | 581 | 0.75 | 0.15 | 0.60 | 87 |
| 1C₁₈TAB + 6TMB | 5.1 | 908 | 468 | 440 | 0.70 | 0.19 | 0.51 | 80 |
| 1C₁₈TAB + 12TMB | 6.8 | 898 | 573 | 324 | 0.64 | 0.23 | 0.41 | 72 |

^{a}S_{BET} = BET surface area (total surface area);
^{b}S_{micro} = micropore surface area, t-plot method;
^{c}Sₑₓₜₑᵣₙₐₗ = external surface area;
^{d}V_{micro} = micropore volume, t-plot method;
^{e}Vₘₑₛₒ = mesopore volume, BJH adsorption branch;
^{f}Yield = (weight of inorganics after final synthesis step/weight of inorganics originally into the synthesis) where inorganic refers to aluminosilicate zeolite.

The PXRD patterns of the samples synthesized in the C₁₈TAB-templated system show a similar relative crystallinity compared to parent CBV 720 zeolite. This trend is consistent with literature results for a C₁₈TAB-templated mesoporous Y synthesis, albeit at a higher crystallization temperature. Others have previously observed significant crystallinity decreases relative to CBV720 upon synthesizing mesoporous Y using a C₁₈TAB surfactant. Details in the synthesis conditions outside of the surfactant used may be responsible for different crystallinity outcomes.

### Effect of Cosolvents in the C₁₈TAB-Directed Syntheses

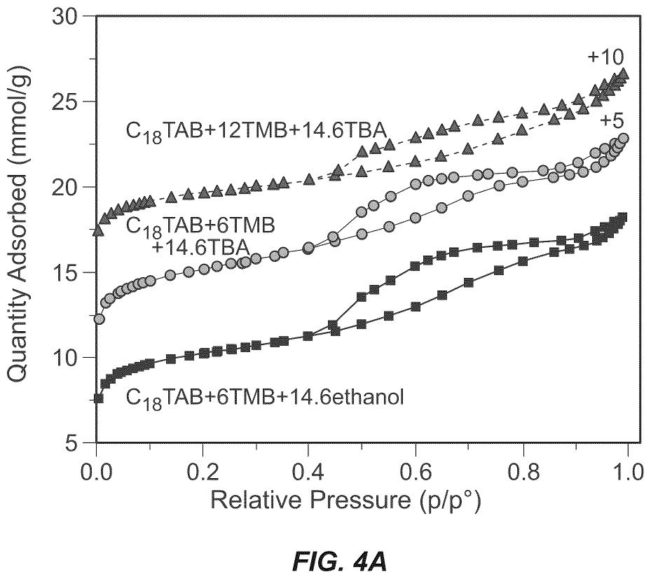

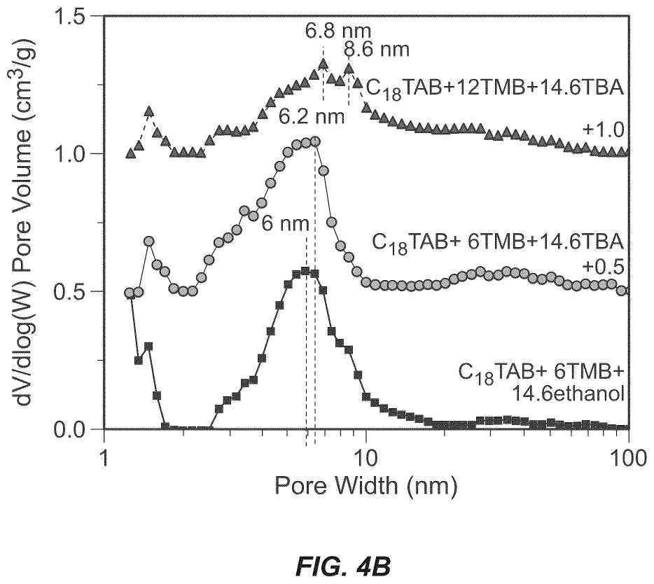

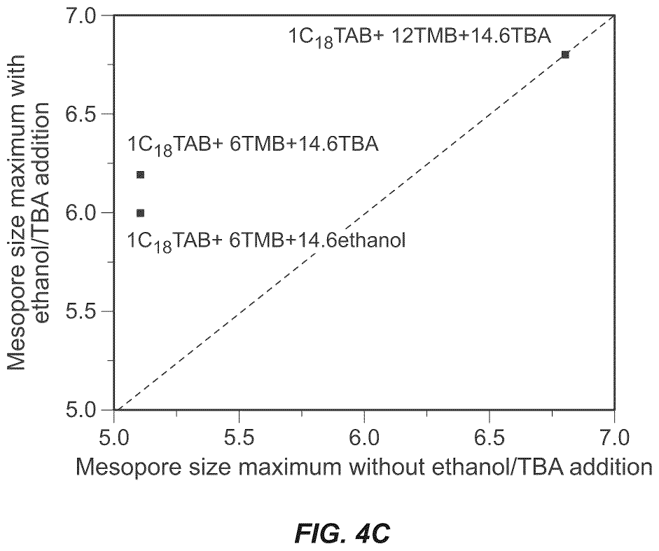

Data in FIGS. 4A-C demonstrate that the addition of ethanol at a TMB/C₁₈TAB ratio of 6 results in a mesopore size of 6.0 nm, which is larger than the 5.1 nm size corresponding to the control sample synthesized in the absence of ethanol in FIGS. 3A-D. Such a result is qualitatively different from the data in the C₁₆TAB-directed synthesis, where no mesopore size expansion was observed with the addition of ethanol.

Upon adding TBA, the C₁₈TAB-templated sample synthesized with a TMB/C₁₈TAB ratio of 6 resulted in a mesopore size of 6.2 nm, which is slightly higher than the material described above with the addition of ethanol. FIG. 4C indicates that the addition of cosolvents increases the mesopore size at a TMB/C₁₈TAB ratio of 6 by 21.6% (1.1 nm; TBA as the cosolvent) and 17.6% (0.9 nm; ethanol as the cosolvent). However, upon increasing the TMB/C₁₈TAB ratio to 12, a bimodal mesopore size distribution was obtained at 6.8 nm and 8.6 nm, respectively, after TBA addition, see FIG. 4B. The same mesopore size distribution resulted in the absence of TBA at a TMB/C₁₈TAB ratio of 12 (i.e. Sample 1C₁₈TAB+12TMB in FIG. 3B). It has been concluded that the addition of TBA contributes little to the mesopore expansion at a TMB/C₁₈TAB ratio of 12.

As shown in Table 4 below, at a C₁₈TAB/TMB ratio of 6, the addition of cosolvents (both ethanol and TBA) decreases the mesopore volume compared to the result in Table 3, in the absence of cosolvents. At a C₁₈TAB/TMB ratio of 12, although the mesopore size distribution is unchanged, the addition of TBA also decreased the mesopore volume compared to the comparator with the absence of TBA (Table 3). The recovered yields were similar to syntheses in the absence of these cosolvents. The corresponding PXRD patterns exhibit similar relative crystallinity to the comparator without cosolvent, which is consistent with results in the C₁₆TAB-templated system.

TABLE 4
Textural properties of the samples at different
TMB/C₁₈TAB ratios with the presence of TBA or ethanol.

| | Mesopore | | | | | | | |
|---|---|---|---|---|---|---|---|---|
| | size | Surface area (m²/g) | | | Volume (cm³/g) | | | Yield^{f} |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} | (%) |
| 1C₁₈TAB + 6TMB + 14.6ethanol | 6.0 | 858 | 540 | 317 | 0.65 | 0.22 | 0.43 | 85 |
| 1C₁₈TAB + 6TMB + 14.6TBA | 6.2 | 846 | 471 | 375 | 0.62 | 0.19 | 0.43 | 74 |
| 1C₁₈TAB + 12TMB + 14.6TBA | 6.8/8.6 | 806 | 535 | 271 | 0.57 | 0.21 | 0.36 | 76 |

^{a}S_{BET} = BET surface area (total surface area);
^{b}S_{micro} = micropore surface area, t-plot method;
^{c}Sₑₓₜₑᵣₙₐₗ = external surface area;
^{d}V_{micro} = micropore volume, t-plot method;
^{e}Vₘₑₛₒ = mesopore volume, BJH adsorption branch;
^{f}Yield = (weight of inorganics after final synthesis step/weight of inorganics originally into the synthesis) where inorganic refers to aluminosilicate zeolite.

It has been found that swelling agents, cosolvents, and cosurfactants can impact the mesopore size distribution in C₁₆TAB- and C₁₈TAB-templated mesoporous Y syntheses. Although surfactants with longer alkyl chain length produced slightly larger mesopore sizes, adding swelling agents extended the mesopore size further, with TMB exhibiting a stronger mesopore size expansion effect than p-xylene. A sample synthesized with a TMB/C₁₈TAB ratio of 12 exhibited the largest mesopore size of 6.8 nm, with a mesopore volume of 0.41 cm³/g. The addition of cosolvents could also alter the mesopore size, with TBA generally showing a stronger effect at mesopore expansion compared to ethanol, but the effect of cosolvent addition became less pronounced as the TMB/CₙTAB ratio increased.

Acid-site catalytic accessibility in the mesoporous Y zeolite with the largest pore size obtained was shown in the acylation of 2-MN with acetic anhydride (Ac₂O) as a probe reaction. Data in Table 5 demonstrate that both C₁₈TAB-templated (pore size 4.3 nm) and C₁₈TAB+12TMB-templated (pore size 6.8 nm) exhibit high selectivity to 1,2-AMN, which is consistent with the literature data, although much higher reaction temperatures were used in the literature (100° C. and 150° C.) than in the present process, e.g., 50° C. or less, 20-50° C., with 40° C. in one embodiment. A similar conversion was observed for both materials (18.3%-20.0%), suggesting that the present supramolecular approach-maintained acid-site integrity and accessibility found in conventional mesoporous Y zeolites. This is consistent with the gentle nature of the non-covalent interactions and organic additives used for mesopore expansion in the present method.

TABLE 5
Expanded mesoporous Y zeolite catalysis of 2-MN acylation with Ac₂O.^{a}

| | | 1,2-AMN | Mesopore | Micropore | External |
|---|---|---|---|---|---|
| | Conversion | Selectivity | pore size | surface area/ | surface area/ |
| Sample | (%) | (%) | (nm) | (m²/g) | (m²/g) |
| C₁₈TAB | 18.3% | >97 | 4.3 | 359 | 581 |
| C₁₈TAB + 12 TMB | 20.0% | >97 | 6.8 | 573 | 324 |

^{a}Reaction conditions: T = 40° C., atmospheric pressure, catalyst weight = 100 mg, AC₂O: 2-MN = 3:1 mmol, 10 mL 1,2-dichloroethane (DCE) as solvent, reaction time = 10 min.

Larger pores in CₙTAB-templated (n=16 and 18) mesoporous Y zeolites can be achieved via a non-covalent approach involving the addition of swelling agents and cosolvents during the present surfactant-assembly and materials synthesis process. TMB exhibited a stronger mesopore size expansion effect than both p-xylene and DIPB as swelling agents, indicating an optimum hydrophobicity of the swelling agent. A sample synthesized with a TMB/C₁₈TAB ratio of 12 exhibited the largest mesopore size of 6.8 nm, with a mesopore volume of 0.41 cm³/g, and showed the same catalytic accessibility and rate as a conventional mesoporous Y zeolite. It was also found that the addition of cosolvents could alter the mesopore size, with TBA generally showing a stronger effect at mesopore expansion compared to ethanol, but the effect of cosolvent addition is less pronounced as the TMB/CₙTAB ratio increases. The addition of swelling agents and cosolvents decreased the mesopore pore volume due to their effect on decreasing [OH⁻] activity, but this can be compensated by using a higher NaOH concentration, while maintaining the same enlarged mesopore size distribution afforded by the organic additives. When a large excess of TMB is reacted postsynthetically at high temperature with an as-made conventional mesoporous Y material, little change in the maximum of the pore size distribution was observed, and only a slight synthesis of larger mesopores in the 9.4-17.0 nm range was observed. These results emphasize the importance of adding organic additives during mesoporous Y synthesis, when the surfactant assembly has greater flexibility to swell.

In spite of the present efforts, it is difficult to synthesize mesoporous Y materials with mesopore sizes larger than 10 nm, and alternative routes for the synthesis of such larger mesopores are needed in mesoporous Y zeolite materials.

As used in this disclosure the word “comprises” or “comprising” is intended as an open-ended transition meaning the inclusion of the named elements, but not necessarily excluding other unnamed elements. The phrase “consists essentially of’ or “consisting essentially of’ is intended to mean the exclusion of other elements of any essential significance to the composition. The phrase “consisting of’ or “consists of’ is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A process for preparing a surfactant-templated mesoporous Y zeolite comprising:
(a) combining sodium hydroxide solution with CTAB and TMB or par-xylene and heating the mixture;
(b) adding the heated mixture of (a) Y zeolite with stirring;
(c) cooling the heated mixture and filtering solids; and
(d) dry and calcine the filtered solids.

2. The process of claim 1, wherein the mixture in (a) is heated for 20-30 minutes.

3. The process of claim 2, wherein the mixture is heated at a temperature in the range of from 85-95° C.

4. The process of claim 2, wherein the Y zeolite is added in (b) after the 20-40 minutes of heating.

5. The process of claim 1, wherein the stirring in (b) continues for 4-7 hours.

6. The process of claim 5, wherein the stirring in (b) continues for about 6 hours.

7. The process of claim 1, wherein after filtering the solids in (c), the filtered solids are washed with water.

8. The process of claim 7, wherein the washing of the solids continues until the filtrate becomes neutral pH.

9. The process of claim 1, where calcining in (d) is at a temperature in the range of from 550-650° C.

10. The process of claim 9, wherein the calcining in (d) is conducted in dry air.

11. The process of claim 1, wherein TMB is combined with CTAB in (a).

12. The process of claim 11, wherein the molar ratio of TMB/CTAB is in the range of 4-12.

13. The process of claim 12, wherein the molar ratio is about 6.

14. The process of claim 12, wherein the molar ratio is about 12.

15. The process of claim 11, wherein the CTAB is C₁₆TAB.

16. The process of claim 11, wherein the CTAB is C₁₈TAB.

17. The process of claim 11, wherein an alcohol is added to the mixture being stirred in (b) after the CBV720 zeolite has been added.

18. The process of claim 11, wherein the alcohol is added from 20 minutes to 40 minutes after the CBV720 zeolite has been added.

19. The process of claim 17, wherein the alcohol is TBA or ethanol.

20. The process of claim 19, wherein the alcohol is TBA.

21. The process of claim 16, wherein TBA is added to the mixture being stirred in (b) after the CBV270 zeolite has been added.

22. The process of claim 11, wherein a nonionic surfactant is also added to the mixture of (a).

23. The process of claim 1, wherein the CTAB is C₁₆TAB for C₁₀TAB.

24. The process of claim 1, wherein p-xylene is combined with CTAB in (a).

25. The process of claim 24, wherein the molar ratio of p-xylene/CTAB is in the range of 4-12.

26. The process of claim 25, wherein the molar ratio is about 6.

27. The process of claim 25, wherein the molar ratio is about 12.

28. The process of claim 24, wherein the CTAB is C₁₆TAB.

29. The process of claim 24, wherein the CTAB is C₁₈TAB.

30. The process of claim 24, wherein an alcohol is added to the mixture being stirred in (b) after the CBV720 zeolite has been added.

31. The process of claim 24, wherein the alcohol is added from 20 minutes to 40 minutes after the CBV720 zeolite has been added.

32. The process of claim 30, wherein the alcohol is p-xylene or ethanol.

33. The process of claim 32, wherein the alcohol is p-xylene.

34. The process of claim 29, wherein TBA is added to the mixture being stirred in (b) after the CBV270 zeolite has been added.

35. The process of claim 1, wherein the Y zeolite in (b) is CBV720.

36. A process for preparing a surfactant-templated mesoporous Y zeolite comprising:
(a) combining sodium hydroxide solution with C₁₈TAB and TMB, and heat the mixture for 20-40 minutes;
(b) add to the heated mixture of (a) a Y zeolite with stirring for 4-7 hours;
(c) cooling the mixture, filtering the solids and wash the filtered solids with water; and
(d) dry and calcine the solids from (c).

37. The process of claim 36, wherein the molar ratio of TMB/C₁₈TAB is in the range of from 4-12.

38. The process of claim 37, wherein the molar ratio is about 12.
